(19) United States
(12) Patent Application Publication
(10) Pub. No.: US 2024/0296762 A1
(43) Pub. Date: Sep. 5, 2024

(54) DETERMINING CORRELATION DEGREE, APPARATUS, ELECTRONIC DEVICE, AND COMPUTER-READABLE STORAGE MEDIUM

(71) Applicants: Beijing Zhongxiangying Technology Co., Ltd., Beijing (CN); BOE Technology Group Co., Ltd., Beijing (CN)

(72) Inventors: Chuan WANG, Beijing (CN); Jianfeng ZENG, Beijing (CN); Nan LIU, Beijing (CN); Yu WANG, Beijing (CN); Haijin WANG, Beijing (CN); Dong CHAI, Beijing (CN); Hong WANG, Beijing (CN)

(21) Appl. No.: 17/919,009

(22) PCT Filed: Aug. 26, 2021
(86) PCT No.: PCT/CN2021/114845

§ 371 Date: Oct. 14, 2022

(51) Int. Cl. G09G 3/00

(52) U.S. Cl. CPC G09G 3/006; G09G 2330/12

(57) ABSTRACT

A method for determining a correlation degree, an apparatus for determining a correlation degree, an electronic device, and a computer-readable storage medium. The method includes: acquiring measurement information and defect information on a display panel, wherein the measurement information includes a measurement value and a measurement location for a measurement indicator, and the defect information includes a defect type; determining an influence weight of the measurement indicator having the measurement value at the measurement location on the defect information of the defect type; and determining a correlation coefficient between the influence weight and the measurement value, and determining a correlation degree between the measurement information and the defect information according to the correlation coefficient. According to the method, it is beneficial to improve the accuracy and speed of analyzing the causes of defects, reduce the cost of analysis, improve the utilization rate of measurement information, and increase the worth of data.

### TECHNICAL FIELD

The present application relates to the field of display technology, and in particular, to a method for determining a correlation degree, an apparatus for determining a correlation degree, an electronic device, and a computer-readable storage medium.

### BACKGROUND

The manufacture of the display panels is affected by the manufacturing process, the environment and other factors, which can lead to more or less problems in the manufactured display panels. During the manufacturing process of the display panels, some indicators can be measured by sampling to obtain measurement information for subsequent analysis.

At present, analyzing a defect mainly includes marking measurement information at a corresponding location in the display panel and displaying defect information on the display panel, then determining a degree of influence of the indicator on the defect by comparing the location of the measurement information and the location of the defect information with human eyes.

This determination method is mainly based on manual effort, which can be affected by subjective factors and experience, the accuracy cannot be secured, and the efficiency is low. The utilization rate of measurement information is also low, and it is difficult to achieve scale and standardization.

### SUMMARY

The present disclosure provides a method for determining a correlation degree, an apparatus for determining a correlation degree, an electronic device, and a computer-readable storage medium, in order to address the deficiency in the related art.

According to a first aspect of examples of the present disclosure, there is provided a method for determining a correlation degree, including: acquiring measurement information and defect information on a display panel, wherein the measurement information includes a measurement value and a measurement location for a measurement indicator, and the defect information includes a defect type; determining an influence weight of the measurement indicator having the measurement value at the measurement location on the defect information of the defect type; and determining a correlation coefficient between the influence weight and the measurement value, and determining a correlation degree between the measurement information and the defect information according to the correlation coefficient.

Optionally, the measurement indicator includes at least one of: film thickness, resistance, turn-on voltage.

Optionally, the defect type includes at least one of: bright spot, dark spot, bright line, dark line, touch failure, resistance.

Optionally, the defect information further includes a defect location, and determining an influence weight of the measurement indicator having the measurement value at the measurement location on the defect information of the defect type includes: for each measurement location, determining an influence weight according to the measurement location and the defect location.

Optionally, for each measurement location, determining an influence weight according to the measurement location and the defect location includes:
for each measurement location x₀, y₀, determining the influence weight by

$$Y \text{?} = \sum \text{?} {e}^{- k} \text{?} ,$$

$$\text{?} \text{indicates text missing or illegible when filed}$$

where x_{dft}, y_{dft} denotes a defect location, k denotes an attenuation parameter, and R denotes a range parameter.

Optionally, the method further includes: among the defect locations, determining a target defect location having a distance to the measurement location smaller than a distance threshold;
wherein the distance threshold is determined based on R, and x_{dft}, y_{dft} belongs to the target defect location.

Optionally, the defect information does not include defect location, and determining an influence weight of the measurement indicator having the measurement value at the measurement location on the defect information of the defect type includes: determining the influence weight as a preset value.

Optionally, determining a correlation coefficient between the influence weight and the measurement value includes: determining a correlation coefficient according to at least one correlation coefficient determination algorithm.

Optionally, determining a correlation coefficient between the influence weight and the measurement value further includes: determining a confidence level for the correlation coefficient.

Optionally, determining a correlation coefficient according to at least one correlation coefficient determination algorithm includes: respectively determining independent correlation coefficients of the influence weight and the measurement value according to a plurality of correlation coefficient determination algorithms; wherein determining a correlation coefficient between the influence weight and the measurement value includes: determining a correlation weight of each of the independent correlation coefficients according to the confidence level of each of the independent correlation coefficients; and calculating a weighted sum of the independent correlation coefficients according to the correlation weights to obtain a joint correlation coefficient.

According to a second aspect of examples of the present disclosure, there is provided an apparatus for determining a correlation degree, including: one or more processors configured to: acquire measurement information and defect information on a display panel, wherein the measurement information includes a measurement value and a measurement location for a measurement indicator, and the defect information includes a defect type; determine an influence weight of the measurement indicator having the measurement value at the measurement location on the defect information of the defect type; and determine a correlation coefficient between the influence weight and the measurement value, and determine a correlation degree between the measurement information and the defect information according to the correlation coefficient.

According to a third aspect of examples of the present disclosure, there is provided an electronic device, including a processor; a memory for storing processor-executable instructions; wherein the processor is configured to implement the method for determining a correlation degree described above.

According to a fourth aspect of examples of the present disclosure, there is provided a computer-readable storage medium on which a computer program is stored, wherein when the program is executed by a processor, steps in the method for determining a correlation degree described above are implemented.

According to the embodiments of the present disclosure, after the measurement information on the display panel during a manufacturing process and the defect information after the manufacture is obtained, an intermediate indicator can be determined, which is used to reflect the influence of the measurement point on the surrounding defects, so as to facilitate subsequent determination of a correlation degree between the measurement information and the defect information based on the intermediate indicator.

The influence weight of the measurement indicator having the measurement value at the measurement location on the defect information of the defect type can be determined as an intermediate indicator, then a correlation coefficient between the influence weight and the measurement value can be determined, and the correlation degree between the measurement information and the defect information is determined.

Accordingly, by constructing the influence weight to reflect the influence of the measurement point on the surrounding defects, the correlation degree between the measurement information and the defect information can be constructed, and then the correlation degree between the measurement information and the defect information can be quantitatively determined through the correlation calculation. It is beneficial to improve the accuracy and speed of analysis of defect causes, reduce analysis costs, improve the utilization of measurement information, and increase the utilization of data.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic flowchart of a method for determining a correlation degree according to an embodiment of the present disclosure.

FIG. 2 is a schematic diagram of acquiring measurement information and defect information according to an embodiment of the present disclosure.

FIG. 3 is a schematic flowchart of another method for determining a correlation degree according to an embodiment of the present disclosure.

FIG. 4 is a schematic diagram showing a relationship between a range parameter and an influence weight according to an embodiment of the present disclosure.

FIG. 5 is a schematic flowchart of yet another method for determining a correlation degree according to an embodiment of the present disclosure.

FIG. 6 is a schematic flowchart of yet another method for determining a correlation degree according to an embodiment of the present disclosure.

FIG. 7 is a schematic flowchart of another method for determining a correlation degree according to an embodiment of the present disclosure.

FIG. 8 is a schematic block diagram of an apparatus for determining a correlation degree according to an embodiment of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

FIG. 1 is a schematic flowchart of a method for determining a correlation degree according to an embodiment of the present disclosure. The method shown in this embodiment can be applied to devices such as terminals and servers.

As shown in FIG. 1, the method can include the following steps.

In step S101, measurement information and defect information on a display panel are acquired, wherein the measurement information includes a measurement value and a measurement location for a measurement indicator, and the defect information includes a defect type.

In step S102, an influence weight of the measurement indicator having the measurement value at the measurement location on the defect information of the defect type is determined.

In step S103, a correlation coefficient between the influence weight and the measurement value is determined, and a correlation degree between the measurement information and the defect information is determined according to the correlation coefficient.

In one embodiment, the display panel includes a liquid crystal display (LCD) panel, an organic light-emitting diode (OLED) display panel.

A display panel includes a plurality of film layers. For example, in an array substrate of a display panel, in order to manufacture a thin film transistor, a plurality of film layers are manufactured. In the manufacturing process of the display panel, sampling measurement can be performed for each film layer, and specifically, measurement can be performed for one or more measurement indicators on the film layer.

In one embodiment, the measurement indicator includes at least one of the following: film thickness, resistance, and on-voltage. Subsequent embodiments mainly focus on the measurement indicator of film layer thickness, and the technical solution of the present disclosure will be described with the measurement indicator of film layer thickness as an example.

In one embodiment, the measurement information obtained by performing sampling measurement on the film layer during the manufacturing process, and the defect information determined on the display panel during and after the manufacturing process can be stored in a Yield Manager System (YMS) database, and then the required information can be extracted from the YMS database (for example, extracted with structured query language SQL), and stored in an Hbase database in a form suitable for subsequent operations.

The measurement information includes measurement values obtained by performing sampling measurement on one or more physical quantities of the film layer (such as the above-mentioned resistance, film thickness and other indicators) during the manufacturing process. The defect information includes test results of one or more film layers during the manufacturing process and/or one or more functions of the display panel after the manufacturing is completed, such as display function, touch function, and so on. For example, for the display function, the defect information can include one or more defect types, such as bright spot, dark spot, bright line, dark line, and so on.

In one embodiment, the measurement information can be obtained by performing sampling measurement when the film layer is fabricated on the original glass substrate Glass, or by performing sampling measurement when the film is fabricated on Half-Glass, two half substrates A and B obtained by half-cutting the original glass substrate Glass. The defect information is obtained after the original glass substrate has been cut into the final panel.

Since coordinate systems on Glass, Half-Glass and the panel are different, for the measurement information obtained by sampling measurement when the film is produced from Glass, the measurement information obtained by sampling measurement when the film is produced from Half-Glass, and defect information determined on the panel, coordinate systems can be converted to the same coordinate system, for example, to the coordinate system on Glass.

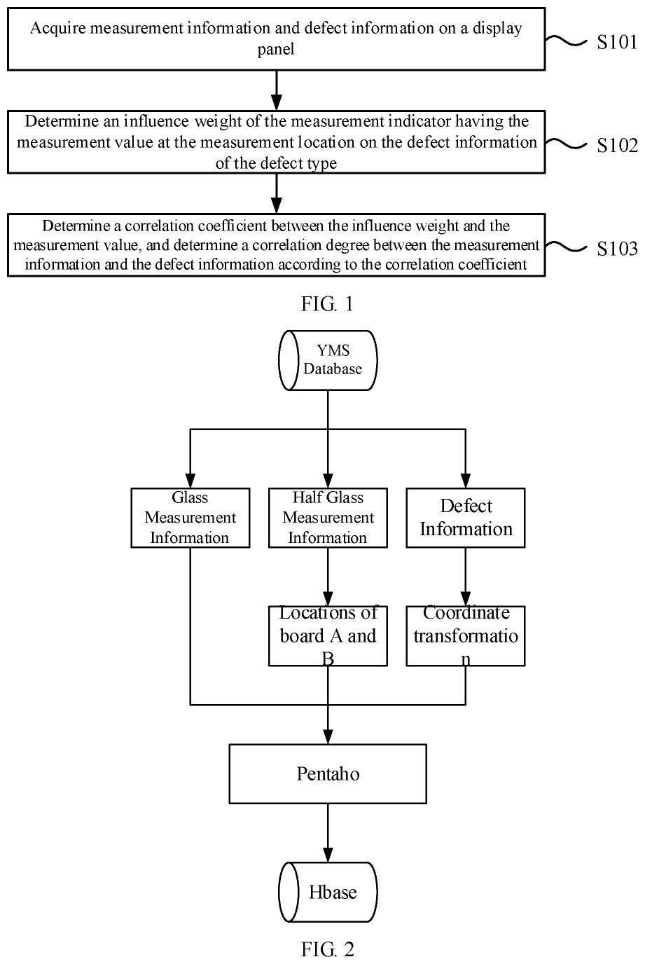

FIG. 2 is a schematic diagram of acquiring measurement information and defect information according to an embodiment of the present disclosure.

As shown in FIG. 2, data can be extracted from the YMS database with SQL. The extracted data includes three aspects, namely measurement information obtained by performing sampling measurement when the film is produced from Glass, and measurement information obtained by performing sampling measurement when the film is produced from Half-Glass, defect information determined on the panel.

For measurement information obtained by performing sampling measurement when the film is produced from Half-Glass, it can be determined whether it belongs to a board A or a board B, so as to convert the coordinates into the coordinate system of Glass. For the defect information determined on the panel, the coordinates can also be converted to the coordinate system of Glass.

Then, the three aspects of data can be input into an Extract Transform Load (ETL) tool, such as Pentaho, for processing, and finally stored in the Hbase database.

In one embodiment, the measurement information obtained by sampling measurement when the film layer is produced from Glass, the measurement information obtained by sampling measurement when the film layer is produced from Half-Glass, and the defect information determined on the panel can be stored in the Hbase database in form of the following three tables.

TABLE 1
Glass Measurement Information Table

| | | |
|---|---|---|
| Item | Data | Remarks |

| | |
|---|---|
| ROWKEY | Glass ID |
| ${Station}\x00${Indicator | Measurement Location and |
| Name} | Value |

The measurement information obtained by forming the film layer on Glass can be stored in the form of Table 1.

The Glass ID of the Glass under test can be selected as the primary key ROWKEY, station represents a site where the measurement is performed, and the indicator name is also the above measurement indicator, including but not limited to film thickness, resistance, on-voltage, and so on. For each indicator, the measurement location and the value as measured, that is, the measurement value, can be determined, and are stored in Table 1.

TABLE 2
Half-Glass Measurement Information Table

| Item | Data | Remarks |
|---|---|---|
| ROWKEY | Half-Glass ID | |
| AB | Storing the location | Glass is cut to |
| | of Half Glass on | halves, i.e., part |
| | Glass | A and part B |
| ${Station}\x00${Indicator | Measurement Location | |
| Name} | and Value | |

The measurement information obtained by forming the film layer on Half-Glass can be stored in the form of Table 2.

The Half-Glass ID of the half-Glass under test can be selected as the primary key ROWKEY, station represents a site where the measurement is performed, and the indicator name is the above measurement indicator, including but not limited to film thickness, resistance, on-voltage, and so on. The measurement of each indicator can determine the measurement location and the value as measured, that is, the measurement value, which is stored in Table 2. In addition, in order to facilitate coordinate system conversion, the location of Half Glass in Glass can also be stored in Table 2.

TABLE 3
Defect Information Table

| Item | Data | Remarks |
|---|---|---|
| ROWKEY | Panel ID | |
| ${Defect Code} | Defect location (x, y) where | Location should be |
| | defect occurs, if no | converted to coordinates |
| | specific coordinates, | of Glass |
| | Use NaN as coordinates | |

The defect information determined on the Panel can be stored in the form of Table 3.

The Panel ID of the panel where the defect information is located can be selected as the primary key ROWKEY, and the Defect Code represents the defect type. In one embodiment, the defect type includes at least one of the following: bright spot, dark spot, bright line, dark line, touch failure, resistance.

For defect information, if the location, such as a bright spot, can be determined, the defect location where the defect occurs can be recorded, and the coordinates of the defect location need to be converted into the coordinate system of Glass for representation, so that the operation can be performed in the same coordinate system as the measurement location; For defect information whose location cannot be determined, such as touch failure, NaN (Not a Number) can be used as the coordinates.

According to the embodiments of the present disclosure, after the measurement information on the display panel during a manufacturing process and the defect information after the manufacture is obtained, an intermediate indicator can be determined, which is used to reflect the influence of the measurement point on the surrounding defects, so as to facilitate subsequent determination of a correlation degree between the measurement information and the defect information based on the intermediate indicator.

The influence weight of the measurement indicator having the measurement value at the measurement location on the defect information of the defect type can be determined as an intermediate indicator, then a correlation coefficient between the influence weight and the measurement value can be determined, and the correlation degree between the measurement information and the defect information is determined.

Accordingly, by constructing the influence weight to reflect the influence of the measurement point on the surrounding defects, the correlation degree between the measurement information and the defect information can be constructed, and then the correlation degree between the measurement information and the defect information can be quantitatively determined through the correlation calculation. It is beneficial to improve the accuracy and speed of analysis of defect causes, reduce analysis costs, improve the utilization of measurement information, and increase the utilization of data.

In one embodiment, the correlation coefficient can be used as the correlation degree of the defect information, or the correlation coefficient can be further processed as the correlation degree, for example, multiplied by a proportional coefficient and used as the correlation degree.

In one embodiment, the method for detecting defect information can include the following steps A to D.

In step A, defect information on the current film layer and the defect information on the historical film layer are acquired, wherein the historical film layer is formed before the current film layer.

In step B, a target location of the defect information on the current film layer is determined, and it is determined whether there is defect information at a corresponding location of the target location in the historical film layer.

In step C, if there is defect information at the target location in the historical film layer, the defect information detected at the target location in the current film layer is deleted.

In step D, if there is no defect information at the target location in the historical film layer, the defect information detected at the target location in the current film layer is retained.

In one embodiment, the implementation of detecting the defect information can be selected according to needs, for example, the detection can be performed by means of Automated Optical Inspection (AOI).

In one embodiment, the current film layer can be the newly formed film layer, and each time a film layer is formed after the first film layer (e.g., the bottommost film layer) is formed, the Steps A to D can be executed taking the formed film layer as the current film layer.

In one embodiment, when defect information is detected, the location (e.g., coordinates) where the defect information is located can be recorded.

In one embodiment, in the process of manufacturing the display panel, if the glass substrate needs to be cut to obtain a plurality of display panels, and the detection of the defect information occurs before the cutting, the location of the defect information on the glass substrate can be recorded first. After cutting, the display panel where the defect information is located and the coordinates in the display panel are determined based on the cutting manner. The display panel in all the embodiments of the present disclosure can refer to a display panel after cutting.

According to the above steps A to D, when defect information is detected at the target location in the current film layer, the detected defect information is not directly recorded, but whether there is also defect information at the corresponding location (for example, the target location) or the location within a certain range of the target location in the previously formed historical film layer can be determined.

If there is also defect information, it means that the defect information at the target location in the current film is caused by the defect information at the target location in the historical film, so the defect information at the target location in the current film can be deleted; if there is no defect information, which means that the defect information at the target location in the current film is not caused by the defect information on the historical film at the target location, but due to the factors of the current film itself (the implementation environment of the current film, the process of forming the current film layer, etc.), so the defect information at the target location in the current film layer can be retained.

Accordingly, for the defect information on the current film layer, only the defect information caused by the current film layer itself can be retained, and it is not necessary to retain the defect information caused by the historical film layer. On the one hand, it can reduce the amount of stored data, and on the other hand, the complexity of subsequent analysis of defect information can be simplified.

In one embodiment, determining whether there is defect information in the corresponding location of the target location in the historical film layer includes: determining whether there is defect information within a preset distance threshold range of the target location in the historical film layer; if there is defect information, determining whether there is defect information in the corresponding location of the target location in the historical film layer.

In one embodiment, when defect information on the historical film layer causes defect information to appear in the current film layer, due to factors such as the manufacturing process, film layer structure, etc., there can be subtle differences in the location of defect information on the historical film layer and the location of defect information on the current film layer.

Therefore, when determining whether there is defect information in the corresponding location of the target location in the historical film layer, it can be determined whether there is defect information within the preset distance threshold range of the target location in the historical film layer. For example, a distance between the coordinates of the defect information in the historical film and the coordinates of the target location in the historical film can be calculated. When the distance is smaller than the distance threshold, it can be determined that there is defect information in the target location in the historical film, and if the distance is larger than the distance threshold, it can be determined that there is no defect information at the target location in the historical film.

In the case where the distance is equal to the distance threshold, it can be regarded as the distance is smaller than the distance threshold or the distance is larger than the distance threshold as required.

In one embodiment, in the case of a line defect in the current film layer, such as a row-direction defect, a column-direction defect, a diagonal line-direction defect, etc., a corresponding straight line of the line defect can be determined in the historical film layer, and then it is determined whether there is defect information whose distance to the straight line is smaller than the preset distance threshold. If there is such defect information, it is determined that defect information exists at the corresponding location of the target location in the historical film layer.

In one embodiment, determining whether there is defect information within a preset distance threshold range of the target location in the historical film layer includes: when there is a row-direction defect in the current film layer, determining whether there is defect information within a preset distance threshold range of the target location in a column direction in the historical film layer; if such defect information exists, determining that defect information exists at the corresponding location of the target location in the historical film layer.

In one embodiment, determining the distance between the defect location where the defect information exists in the historical film layer and the target location includes: when there is a column-direction defect in the current film layer, determining whether there is defect information within a preset distance threshold range of the target location in a row direction in the historical film layer; if such defect information exists, determining that defect information exists at the corresponding location of the target location in the historical film layer.

Since the structure in the display panel generally affects the entire row of pixels, or the entire column of pixels, for example, a search line defect can affect the entire row of pixels, and a data line defect can affect the entire column of pixels. Therefore, defect information in the film layer can be defect in the row direction, for example, the entire row of pixels does not light up or the light emission is uncontrollable, or defect in the column direction, for example, the entire column of pixels does not light up or the light emission is uncontrollable.

For the row-direction defect, the defect information extends to the entire panel in the row direction, which can be regarded as a straight line along the row direction. Then, to determine a distance from a point to a line, only the distance from the point to the perpendicular line direction of the line needs to be considered. For a line along the row direction, it is only necessary to consider a distance from the location of the defect information on the historical film layer to the line in the column direction, that is, to calculate whether there is defect information within a preset distance threshold range of the target location in a column direction in the historical film layer. If such defect information exists, it can be determined that defect information exists at the target location in the historical film layer. Here, the target location can be a line, not just a point.

Correspondingly, for the column-direction defect, the defect information extends to the entire panel in the column direction, which can be regarded as a straight line along the column direction. Then, to determine a distance from a point to a line, only the distance from the point to the perpendicular line direction of the line needs to be considered. For a line along the column direction, it is only necessary to consider a distance from the location of the defect information on the historical film layer to the line in the row direction, that is, to calculate whether there is defect information within a preset distance threshold range of the target location in a row direction in the historical film layer. If such defect information exists, it can be determined that defect information exists at the target location in the historical film layer. Here, the target location can be a line, not just a point.

In one embodiment, before acquiring the defect information on the current film layer and the defect information on the historical film layer, the method further includes: determining a defect location of the defect information on the current film layer and cutting information on the display panel where the defect location is located; determining a correlation between coordinates in the display panel and coordinates in the glass substrate where the display panel had been located before the display panel was cut according to the history cutting information; and determining a location of the defect location in the glass substrate according to the correlation.

In the process of manufacturing a display panel, it is generally necessary to cut a relatively large glass substrate to obtain a plurality of relatively small display panels. The film layers described above can include film layers formed before cutting, or can be film layers formed after cutting.

The operation of detecting defect information in the film layer is generally performed after the current film layer is made and before the next film layer is produced. Therefore, for the film layer formed on the glass substrate before cutting, the location of the defect information recorded during the detection is coordinates in the coordinate system of the glass substrate, and for the film layer formed in the display panel after cutting, the location of the defect information recorded during detection is coordinates in the coordinate system of the display panel, which leads to locations of defect information in different film layers can be located in different coordinate systems, and is not convenient for subsequent processing.

In this embodiment, before acquiring the defect information on the current film layer and the defect information on the historical film layer, the defect location of the defect information on the current film layer and the cutting information on the display panel where the defect location is located can be determined.

The cutting information can be, for example, a serial number in the glass substrate where the display panel is located before cutting, a cutting manner of the glass substrate, a spatial correspondence between the serial number and the cutting manner, and the like.

Based on the cutting information, the correlation between the coordinates in the display panel and the coordinates in the glass substrate before the display panel is cut can be determined, and the relationship can represent the relationship between the coordinate system of the glass substrate and the coordinate system of the display panel, including but not limited to rotation, translation and other relationships.

Then, the location of the defect location in the glass substrate is determined according to the relationship. For example, the relationship is a conversion matrix from the coordinate system of the display panel to the coordinate system of the glass substrate. The location information of the defect information detected in the display panel can be converted through the conversion matrix to obtain the location of the defect information on the display panel in the glass substrate.

Accordingly, the location information of the defect information in all the display panels can be converted into the coordinate system of the glass substrate, which is convenient for subsequent processing, such as determining the target location of the defect information on the current film layer, and determining whether there is defect information at the corresponding location of the target location in the historical film layer, and performing operations such as aggregation of the defect information.

In one embodiment, determining the defect information further includes: storing the recorded defect information in a first data table; and aggregating the data in the first data table according to technological process information in the manufacturing process, to obtain a second data table; searching for (also called scan scan) data in the second data table according to a received search instruction.

Since multiple layers of films need to be fabricated in the production process of the display panel, there can be a lot of pieces of defect information detected on each film layer, so when a large number of display panels are produced in multiple factories, for all display panels in the multiple factories, the amount of detected defect information will be very huge.

According to this embodiment, the recorded defect information can be stored in the first data table first, and then the data in the first data table can be aggregated according to the technological process information in the manufacturing process to obtain the second data table, wherein the technological process information includes but is not limited to the following.

Factory (the factory that made the film), Date (the date the film was made), Site (the site that the film is detected), Device (the device the film belongs to), Product (the product the film belongs to), Defect type (the type of defect information in the film layer).

The aggregation of the data in the first data table according to the technological process information in the manufacturing process can refer to integrating multiple pieces of defect information with the same technological process information into one piece of data.

Take the technological process information including date, detection site and defect type as an example, for example, for the following 9 pieces of defect information:
Defect information 1: date 2021.4.25, detection site station1, type codeA1, coordinates (x1, y1);
Defect information 2: date 2021.4.25, detection site station1, type codeA1, coordinates (x2, y2);
Defect information 3: date 2021.4.25, detection site station1, type codeA1, coordinates (x3, y3);
Defect information 4: date 2021.4.25, detection site station1, type codeA1, coordinates (x4, y4);
Defect information 5: date 2021.4.25, detection site station1, type codeA2, coordinates (x5, y5);
Defect information 6: date 2021.4.25, detection site station1, type codeA2, coordinates (x6, y6);
Defect information 7: date 2021.4.25, detection site station1, type codeA2, coordinates (x7, y7);
Defect information 8: date 2021.4.25, detection site station1, type codeA2, coordinates (x8, y8);
Defect information 9: date 2021.4.25, detection site station1, type codeA2, coordinates (x9, y9);

The dates, detection sites, and types of the above-mentioned defect information 1 to 4 are the same, so these 4 pieces of defect information can be aggregated into one piece of data. The above defect information 5 to 9 have the same dates, detection sites, and types, so these 5 pieces of defect information can be aggregated into one piece of data, so that the above 9 pieces of data can be aggregated into 2 pieces of data. For example, the two pieces of data after aggregation are as follows:

Date 2021.4.25, detection site station1, type codeA1, coordinates (x1, y1), (x2, y2), (x3, y3), (x4, y4); and date 2021.4.25, detection site station1, type codeA2, coordinates (x5,y5), (x6,y6), (x7,y7), (x8,y8), (x9,y9).

Accordingly, multiple pieces of defect information with the same technological process information can be integrated into one piece of data instead of multiple pieces of data, which is beneficial to improve the subsequent search speed.

In one embodiment, the first data table and/or the second data table are data tables in the Hbase database.

Because the HBase database has the characteristics of mass storage, columnar storage, easy expansion, high concurrency, and sparseness, it is convenient to store a large amount of defect information, and the primary key of HBase can be designed according to the technological process information on which the aggregated data is based. Data can be more reasonably stored in the data tables of Hbase.

In one embodiment, the primary key of the first data table is an identification of the display panel; and/or the primary key of the second data table includes at least one of the following: factory, date, detection site, device, product, defective type.

For example, the first data table can be shown in the following table A, and the second data table can be shown in the following table B.

TABLE A

| | Data | |
|---|---|---|
| Element | Description | Remarks |
| ROWKEY | PanelID | Use the identification ID of |
| | | the display panel Panel as the |
| | | primary key RowKey, which |
| | | is convenient for data loading |
| | | and storage |
| INFO: panelId | PanelID | store the PanelID of the |
| | | current panel |
| INFO: productId | productID | store the ID of the product |
| | | Product to which the current |
| | | panel belongs |
| INFO: glassId | glassID | store the ID of the current |
| | | panel in the Glass stage before |
| | | cutting the glass substrate |
| INFO: halfGlassId | Half glass ID | ID of the half glass stage of |
| | | the current Panel in the half |
| | | glass stage of the glass |
| | | substrate |
| INFO: bpLotId | Lot ID | The card holder LOT to which |
| | | the current Panel belongs |
| INFO: panelLocation | panelID | location information of the |
| | | current Panel on the glass |
| | | substrate Glass before cutting |
| ${factory}: ${stationID} | Defect | store defect point information |
| | | of panel |

TABLE B

| Element | Data Description | Remarks |
|---|---|---|
| ROWKEY | ${factory}\0${date}\ | According to the front-end |
| | 0${stationId}\ | query, design rowkey can |
| | 0${equipmentID}\ | be factory, date, site, |
| | 0${productId}\0${dftCode} | device, product, defect type |
| INFO: total | Defect point count | Supports histogram query |
| DATA: points | Stores details of the defect | Support point MAP query |
| | points on the Join (deleted) | |
| LOT: ${lotID} | Aggregated defect count | Support LOT histogram |
| | based on LotID | query |
| LOC: ${loc} | Aggregated defect count | Supports Panel MAP graph |
| | based on location of Panel | query |

In the first data table, the identification of the display panel is used as the primary key to facilitate data loading and storage. In the second data table, the primary key can be set according to the technological process information on which the aggregated data is based. For example, the technological process information and the primary key are the same, so that the aggregated data can be stored in the second data table more reasonably, and it is convenient for subsequent data search in the second data table according to the primary key.

For example, a piece of data obtained by storing multiple pieces of defect information in the second data table can be shown in Table C below.

TABLE C

| | EAC2\x00 |
|---|---|
| | 20191001\x00 |
| | C33000N\x00 |
| | BCXCT01\x00 |
| | ABCD\x00 |
| ROWKEY | AD0100 |
| INFO: total | 5 |
| LOT: A | 3 |
| LOT: B | 2 |
| LOC: A-01 | 2 |
| LOC: B-05 | 2 |
| LOC: B-11 | 1 |
| INFO: points | 98.01\|60.51\|ST01\x00 |
| | 198.1\|160.5\|ST01\x00 |
| | 298.1\|260.5\|ST01\x00 |
| | 180.1\|160.5\|ST02\x00 |
| | 218.1\|262.5\|ST02 |

That is, the data for 5 pieces of defect information:
Factory EAC2, date 20191001, site C33000N, device BCXCT01, product ABCD, defective type AD0100, coordinates (98.01, 60.51);
Factory EAC2, date 20191001, site C33000N, device BCXCT01, product ABCD, defective type AD0100, coordinates (198.1, 160.5);
Factory EAC2, date 20191001, site C33000N, device BCXCT01, product ABCD, defective type AD0100, coordinates (298.1, 260.5);
Factory EAC2, Date 20191001, Site C33000N, device BCXCT01, Product ABCD, Defect Type AD0100, Coordinates (180.1, 160.5);
Factory EAC2, date 20191001, site C33000N, device BCXCT01, product ABCD, defective type AD0100, coordinates (218.1, 262.5);

The factory, date, site, device, product, and defect type of these five pieces of data are all the same. According to the data structure of the second data table, one piece of data in Hbase can be obtained as shown in Table C, so that multiple pieces of defect data can be aggregated into one piece of data, which is convenient for subsequent search.

In one embodiment, determining defect information further includes: calculating and storing at least one of the following items in the second data table: a ratio of the deleted defect information on the current film layer to all defect information on the current film layer a ratio of the recorded defect information on the current film layer to all defect information on the current film layer; and a ratio of the recorded defect information on the current film layer to the defect information on all the film layers.

When the defect information on the current film which is affected by the historical film is deleted, since the deleted defect information also has some effect on analysis, it is not necessary to record the defect information specifically, but such defect information can be counted for subsequent analysis.

In one embodiment, determining the defect information further includes: before determining the target location of the defect information on the current film layer, aggregating the detected defect information according to the display panel to which the detected defect information belongs.

During the detection process, the detection object is all film layers in all display panels. If it is determined for all display panels whether the defect information on the current layer is affected by the defect information on the historical layers, it can be determined that defect information on the current film layer of one display panel is affected by defect information on the historical film layer of another display panel, but this determination result is meaningless, because there is no direct influence between the film layers of different display panels.

Therefore, in this embodiment, before determining the target location of the defect information on the current film layer, the detected defect information can be aggregated according to the display panel to which the detected defect information belongs, so as to ensure that determining whether defect information on the current film layer is affected by defect information on the historical film layer is performed for the same display panel, to avoid recording unnecessary information.

In one embodiment, determining the defect information further includes: before aggregating the detected defect information according to the display panel to which the detected defect information belongs, reading the historical defect information recorded for the historical film layer; loading the defect information detected in the current film layer into the historical defect information.

In the production process of the display panel, a plurality of film layers are generally produced sequentially, the production times of different film layers are different, and even some film layers are not produced on the same day, the defect information detected for each film layer can be stored, then there will be defect information recorded for film layers formed earlier, and defect information recorded for film layers formed later.

In this embodiment, when the current film layer is detected, the historical defect information recorded for the historical film layer can be retrieved, and then the defect information detected in the current film layer is loaded into the historical defect information, so that the loaded information includes defect information of all the film layers in the display panel, for subsequently determining whether there is defect information at the target location in the historical film layer for all the film layers.

In one embodiment, searching for data in the second data table according to the received search instruction includes: receiving a search instruction sent by a client; searching the second data table according to the search instruction; and generating front-end data according to the search result.

In one embodiment, generating front-end data according to the search result includes: displaying a trend of defect information according to the search result; and/or displaying a distribution of defect information according to the search result. By displaying the trend of defect information, it is convenient for the user to check the change of defect information in the time dimension, and by displaying the distribution of defect information, it is convenient for the user to check the distribution of defect information in each film layer of each panel.

In one embodiment, acquiring measurement information and the defect information described in the embodiment of the present disclosure can be implemented based on the data warehouse technology ETL. ETL can be implemented based on Yield Manager System (YMS), Hive (a data warehouse tool), Spark (a computing engine) and Hbase database. For the specific implementation method, reference can be made to the following examples of product information query systems. The following embodiments mainly describe the acquisition of defect information as an example, and are also applicable to acquisition of measurement information.

First, all the detected defect information can be stored in YMS, then the defect information can be extracted from YMS and put into Hive, and then the defect information can be searched out from Hive through Spark and written into the Hbase database. The steps in the above embodiments can be mainly completed through Spark, such as recording, deleting, and aggregating data of defect information.

The user can input a search instruction on the client, and the client can input the search instruction into a server module. The server module is used to interact with HBase, search for data in the second data table of HBase based on the search instruction, and send the data searched out to the client can display it, and the client can display the search result according to settings, such as displaying a histogram, the distribution of defect information, and so on.

The interface of the client can mainly include three parts. A first area is for the user to input search elements, such as a primary key in the second data table. A second area is used to display the trend of search results, such as time on the abscissa and the data amount of defect information on the ordinate. The displayed form can be in a bar chart, or other forms can be set as needed. Other areas in the interface are used to display the location of the defect information in each film layer and the distribution of the defect information in the display panel recorded in steps A to D.

The user can input search elements in the interface of the client, and can generate a search instruction and send it to the server module. The server module searches for data in the second data table of HBase based on the search instruction, and feeds back the search result to the client, and the client displays it in the interface.

In addition, the embodiments of the present disclosure also provide a data detail download function. For example, the data download can be performed based on defect information on a large amount of display panels. For example, the user clicks a bar chart through the interface or enters a LOT ID (each LOT can be d corresponding to a large amount of display panels), the client sends a LOT detail query request to the server module, generates a corresponding query task for the original data table filtered by the front layer, generates a corresponding data detail file, and returns it to the front end for download.

In one embodiment, when data aggregation is performed, a time range can be input first, so as to determine defect information on the historical film layer within the time range.

Then Spark can record the defect information on the current film layer detected by each site from Hive, and when the glass substrate needs to be cut, Spark can also convert the coordinates of the defect information on the glass substrate to the panel after cutting.

When the historical film layer is formed, the defects in the historical film layer can be recorded in the first data table. Then when the current film layer is formed, the defect information on the historical film layer can be obtained from the first data table, and the defect information detected in the film layer is loaded into the defect information on the historical film layer.

Next, the detected defect information can be aggregated according to the display panel to which the detected defect information belongs.

Based on in the steps A to D, recording that the defect information on the current film is not due to the influence of the historical film layer, the recorded result can be updated to the first data table, so that the defect information stored in the first data table includes both defect information on the current film and defect information on the historical film layer.

Finally, the data in the first data table can be aggregated according to the technological process information in the manufacturing process, and the aggregated data can be stored in the second data table, and the primary key of the second data table can be the same as the technological process information.

Steps A to D, and the steps of acquiring measurement information and acquiring defect information in step S101 can be implemented based on a product information query system, which includes a data processing device, a display device, and a distributed storage device. The system can be configured to search for defect information and measurement information of a product, where the product can include a plurality of film layers, and the product includes, but is not limited to, an organic light-emitting diode display panel, a liquid crystal display panel, and the like.

The distributed storage device is configured to store the detected defect information and measurement information on the current film layer and the defect information and measurement information on the historical film layer, wherein the historical film layer is formed before the current film layer.

The data processing device is configured to acquire detected defect information and measurement information on the current film layer from the distributed storage device, determine a target location of the defect information and the measurement information on the current film layer, determine whether there is defect information at the corresponding location of the target location in the historical film layer, when there is defect information at the target position of the historical film layer, delete the defect information detected at the target position in the current film layer, when there is no defect information at the target position of the historical film layer, retain the defect information detected at the target position in the current film layer, and store the measurement information and the retained defect information to the distributed storage device.

The display device is configured to search the distributed storage device for defect information and measurement information according to a received search instruction, and generate front-end data.

In one embodiment, the data processing device is further configured to store the recorded defect information and the measurement information in a first data table; aggregate the data to obtain a second data table. The display device is configured to search the second data table for defect information and measurement information according to the search instruction.

At present, a production line of industrial products includes several process devices, and each process device can affect the yield of the products when abnormal operation or abnormal working parameters occur. When a defective product is produced, the production personnel need to locate the cause of the defective product. However, the process device in the production line or the amount of data generated is relatively large, which increases the complexity of locating the cause, so that it takes a lot of time to locate the device that causes the failure.

The embodiments of the present disclosure provide a product information query system. The product information query system includes a data processing device, a display device and a distributed storage device. The data processing device is respectively connected to the display device and to the distributed storage device.

The distributed storage device is configured to store production data generated by multiple sample production devices (or factory devices). For example, the production data generated by multiple sample production devices includes production records of the multiple sample production devices. For example, the production record includes information on the sample production device that the multiple samples passed through in the production process and the information on the types of defects that occurred. Each sample passes through multiple sample production devices during the production process, and each sample production device participates in the production process for some samples among the multiple samples.

Relatively complete data (such as a database) is stored in the distributed storage device. The distributed storage device can include multiple hardware memories, and different hardware memories are distributed in different physical locations (such as in different factories, or in different production lines), and transfer information between one another through wireless transmission (such as network, etc.), so that the data is distributed and relational, but logically constitutes a database based on big data technology.

For the data flow of the product information query system, a large amount of raw data of different sample production devices, such as the defect information and measurement information of the film layers in the products, are stored in the corresponding manufacturing system, such as Yield Management System (YMS), Fault Detection & Classification (FDC), Manufacturing Execution System (MES) and other systems in relational databases (such as Oracle, Mysql, etc.), and these raw data can be obtained through Data extraction tools (such as Sqoop, kettle, etc.) by extracting the original table and transfer it to a distributed storage device (such as distributed file system, Hadoop Distributed File System, HDFS for short) to reduce the load on sample production devices and the manufacturing system, and facilitate data reading of subsequent analysis device.

The data in the distributed storage device can be stored based on Hive tools and Hbase database format. For example, according to the Hive tool, the above raw data is first stored in the data lake. After that, data cleaning, data conversion and other preprocessing can be performed in the Hive tool according to the application themes and scenarios of the data, and obtain data warehouses with different themes (such as production history, detection data themes, device data themes), and data marts with different scenarios (such as device analysis scenarios, parameter analysis scenarios), such as Hbase. The above data marts can be connected to display devices, analysis devices, etc. through different API interfaces to implement data interaction with these devices.

The data volume of the above raw data is very large due to the fact that multiple sample production devices of multiple factories are involved. For example, all sample production device can generate hundreds of gigabytes of raw data per day, or tens of gigabytes per hour.

In one embodiment, there are mainly two solutions for realizing storage and calculation of massive structured data: a grid computing solution of RDBMS relational database management system (RDBMS); and a big data solution of a distributed file management system (DFS).

DFS-based big data technology allows use of multiple inexpensive hardware devices to build large clusters to process massive amounts of data. For example, the Hive tool is a data warehouse tool based on Hadoop, which can be used for data extraction, transformation and loading (ETL). The Hive tool does not have a special data storage format, nor does it build an index for the data. Users can freely organize the tables and process the data in the database. It can be seen that the parallel processing of distributed file management can meet the storage and processing requirements of massive data. Users can process simple data through SQL queries, and customized functions can be used for complex processing. Therefore, when analyzing the massive data of the factory, it is necessary to extract the data of the factory database into the distributed file system. On the one hand, it will not cause damage to the original data, and on the other hand, the data analysis efficiency can be improved.

In one embodiment, the distributed storage device can be one memory, can be multiple memories, or can be a general term for multiple storage elements. For example, the memory can include: Random Access Memory (RAM), Double Data Rate Synchronous Dynamic Random Access Memory (DDR SRAM), or non-volatile memory, such as disk storage, flash memory (Flash), etc.

The data processing device is configured to implement the above operations of acquiring measurement information and acquiring defect information, and can be implemented based on Spark (a computing engine), for example. The data processing device can obtain the production records of one or more sample production devices from the distributed storage device, such as the defect information and measurement information in the film layer of the product, and can specifically obtain all the data from the distributed storage device (for example, from Hbase), detect defect information and measurement information on the current film layer, and determine the target location of the defect information and measurement information on the current film layer, and determine whether there is defect information at a corresponding location of the target location in the historical film layer, and when defect information exists at the target location in the historical film layer, delete the defect information detected at the target location in the current film layer, and when no defect information exists at the target location in the historical film layer, retain the defect information detected at the target location in the current film layer, and store the measurement information and the retained defect information in the distributed storage device (for example, stored in Hbase).

The display device is configured to display the front-end data interface and interacting with the user. For example, the interface can include the first interface, the second interface, the third interface, and the like described below. For example, the display device can display the processing result of the data processing device.

In one embodiment, the display device can be a display, and can also be a product including a display, such as a television, a computer device (all-in-one or a desktop), a computer, a tablet, a mobile phone, an electronic picture screen, and the like. In one embodiment, the display device can be any device that displays images, whether in motion (e.g., video) or stationary (e.g., still images), and whether texts or images. More specifically, it is contemplated that the embodiments can be implemented in or associated with a wide variety of electronic devices, such as, but not limited to, game consoles, television monitors, flat panel displays, computers monitors, automotive displays (e.g., odometer displays, etc.), navigators, cockpit controls and/or displays, electronic photographs, electronic billboards or signs, projectors, architectural structures, packaging and aesthetic structures (for example, for a display of images of pieces of jewelry), etc.

In one embodiment, the display device described herein can include one or more displays, including one or more terminals with display capabilities, so that the data processing device can send its processed data (e.g., influencing parameters) to the display device, which then displays it. That is to say, through the interface of the display device (i.e., the user interaction interface), the complete interaction between the user and the system for analyzing the causes of sample failures (controlling and receiving the results) can be realized.

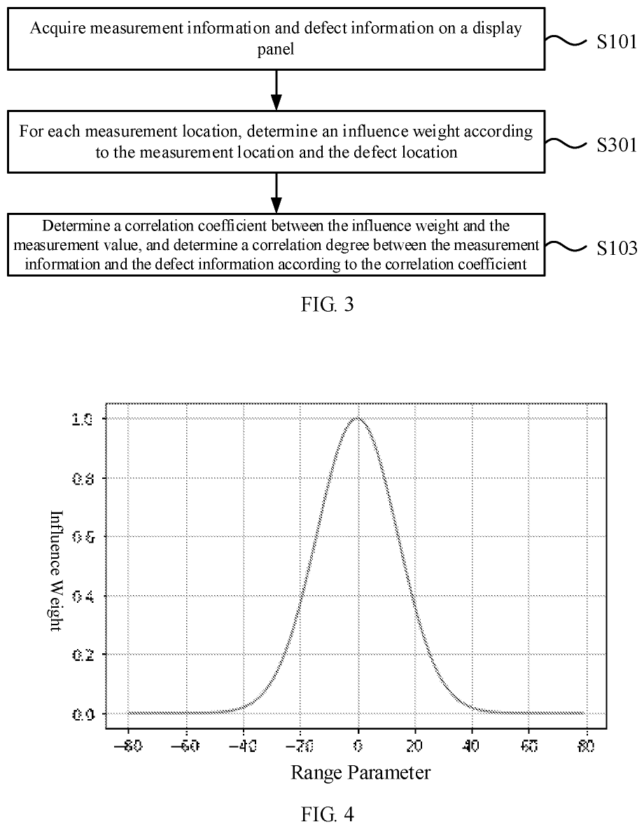

FIG. 3 is a schematic flowchart of another method for determining a correlation degree according to an embodiment of the present disclosure. As shown in FIG. 3, the defect information also includes defect locations. In this case, the defect type in the defect information is a defect type that can determine the defect location, then determining an influence weight of a measurement indicator having a measurement value at the measurement location on the defect information of the defect type includes the following steps.

In step S301, for each measurement location, an influence weight is determined according to the measurement location and the defect location respectively.

In one embodiment, there are various types of defects, and some types of defects can determine the location of the defect, such as bright spots, dark spots, etc., then the location of the defect where the defect occurs can be recorded, but some defect information cannot or is difficult to determine the location of the defect, such as failure in the entire touch display panel, then NaN can be used as the coordinates. For example, defect information can be shown in Table 4 below.

TABLE 4

| | | | Defect |
|---|---|---|---|
| Number | x | y | type |
| 1 | 0 | 0 | bright |
| | | | spot |
| 2 | 100 | 0 | bright |
| | | | spot |
| 3 | 100 | 100 | bright |
| | | | spot |
| 4 | 0 | 100 | bright |
| | | | spot |
| 5 | 80 | 95 | bright |
| | | | spot |
| 6 | 70 | 70 | bright |
| | | | spot |
| 7 | 88 | 90 | bright |
| | | | spot |
| 8 | — | — | Touch |
| | | | failure |
| . . . | | | |

As shown in Table 4, x and y represent horizontal and vertical coordinates, respectively. The defect information of the defective type is bright spots were detected at 7 locations in the display panel, and the touch failure of the display panel was detected.

In one embodiment, sampling measurements can be performed separately for each film layer to obtain measurement information.

| | Film | Parameter | | | |
|---|---|---|---|---|---|
| Number | Layer | Name | x | y | value |
| 1 | GAT1 | THK | 10 | 10 | 1.2 |
| 2 | GAT1 | THK | 90 | 10 | 1.3 |
| 3 | GAT1 | THK | 90 | 90 | 1.5 |
| 4 | GAT1 | THK | 10 | 90 | 1.4 |
| 5 | GAT2 | THK | 10 | 10 | 1.2 |
| 6 | GAT2 | THK | 90 | 10 | 1.3 |
| 7 | GAT2 | THK | 90 | 90 | 1.5 |
| 8 | GAT2 | THK | 10 | 90 | 1.4 |
| . . . | | | | | |

As shown in Table 5, x and y represent the horizontal and vertical coordinates respectively. Taking the measurement indicator as the thickness THK and measuring 4 measurement points in each film layer as an example, in the film layer GAT1, the measurement value of the measurement location (10,10) is 1.2, the measurement value of measurement location (90,10) is 1.3, the measurement value of the measurement location (90,90) is 1.5, the measurement value of the measurement location (10,90) is 1.4; in the film layer GAT2, the measurement value of the measurement location (10, 10) is 1.2, the measurement value of the measurement location (90, 10) is 1.3, the measurement value of the measurement location (90, 90) is 1.5 and the measurement value of the measurement location (10,90) is 1.4.

The units of the horizontal and vertical coordinates and the thickness can be determined according to the actual situation, for example, the units of the horizontal and vertical coordinates are pixels, and the unit of thickness is millimeters.

It should be noted that since the display panel is obtained by dividing the Glass, the display panel generally only corresponds to a part of the area of the Glass, and the measurement information includes the measurement information on the entire range of Glass. When determining an influence weight for defect information on a panel, acquiring measurement information can be: first determining an area corresponding to the panel in Glass, and then acquiring measurement information on the area.

For the defect type of “bright spot” in Table 4, since the defect location where the defect occurs can be determined, and in general, although there is an intuitive feeling that there should be a correlation degree between the measurement information and the defect information, there is currently no indicator to link the two, and the influence weight of the measurement point in the film layer on the defect is related to the measurement location of the measurement point and the defect location where the defect occurs. Therefore, for each measurement point, an influence weight can be determined according to the measurement location and the defect location, and the influence weight is then used as an intermediate indicator to link the measurement information and the defect information, and then a correlation degree between the measurement information and the defect information can be determined according to the influence weight.

In one embodiment, the influence weight is inversely related to the distance between the measured location and the defect location. For example, the distance between the measurement location and the defect location can be determined first according to the measurement location and the defect location, and then a relationship formula between the influence weight and the distance can be established, and the distance and the influence weight are inversely correlated. That is to say, the farther away the defect location is from the measurement point, the less influence the measurement point has on the defect location.

In one embodiment, for each of the measurement locations, determining an influence weight according to the measurement location and the defect location respectively includes:

for each of the measurement locations (x₀, y₀), determining an influence weight:

$$Y \text{?} = \sum \text{?} {e}^{- k} \text{?} ;$$

$$\text{?} \text{indicates text missing or illegible when filed}$$

where (x_{dft}, y_{dft}) denotes a defect location, k denotes an attenuation parameter, and R denotes a range parameter.

In one embodiment, in addition to considering the measurement location and the defect location, other parameters can be further considered to determine the influence weight, such as the attenuation parameter k and the range parameter R.

Both k and R can be set. By adjusting k, the attenuation speed of the distance can be controlled. By adjusting R, the considered range of the defect location near the measurement point that participates in the determination of the influence weight can be adjusted. The formula for determining the influence weight can be flexibly adjusted, so that the influence weight can be reasonably determined according to the actual needs. For example, it can be set k=1, R=20 mm.

It should be noted that, in the above determination formula, for each measurement point, the influence weight of the measurement point on all defect locations needs to be determined. For example, taking Table 4 and Table 5 as examples, for the measurement point (10, 10) in the film layer GTA1, it is necessary to substitute the 8 locations in Table 4 into the above determination formula for summation, and determine the result influence weight Y indicating that the measurement value of the measurement point (10, 10) in the film layer GTA1 is 1.2, the influence weight of the defect type of “bright spot” in Table 4; and so on, for the 4 measurement points in the film layer GTA1 in Table 5, 4 influence weights can be obtained. For the 4 measurement points in the film layer GTA2 in Table 5, 4 influence weights can also be obtained.

In one embodiment, the defect information does not include defect location, in which case the defect type in the defect information is a defect type for which defect locations cannot be determined, then determining an influence weight of a measurement indicator having a measurement value at a measurement location on defect information of a defect type includes: determining the influence weight as a preset value. For example, the influence weight can be set to 1, and for the case where there is no defect information, the influence weight can be set to 0.

Still taking the above Table 4 and Table 5 as examples, for the type of touch failure, for the 4 measurement points in the film layer GTA1 in Table 5, 4 influence weights can be obtained, all of which are 1. For the 4 measurement points in the film layer GTA2 in Table 5, 4 influence weights can also be obtained, all of which are also 1.

Then, on the basis of Table 4 and Table 5, for the two types of “bright spot” and “touch failure”, the determined influence weights can be shown in Table 6.

| | | | | | Measurement | | |
|---|---|---|---|---|---|---|---|
| | | | Target defect | Film | parameter | | Influence |
| Number | x | y | type | layer | name | value | weight |
| 1 | 10 | 10 | bright spot | GAT1 | THK | 1.2 | 0.60653 |
| | 10 | 10 | bright spot | GAT2 | THK | 1.2 | 0.60653 |
| | 10 | 10 | touch failure | GAT1 | THK | 1.2 | 1 |
| | 10 | 10 | touch failure | GAT2 | THK | 1.2 | 1 |
| 2 | 90 | 10 | bright spot | GAT1 | THK | 1.3 | 0.606576 |
| | 90 | 10 | bright spot | GAT2 | THK | 1.3 | 0.606576 |
| | 90 | 10 | touch failure | GAT1 | THK | 1.3 | 1 |
| | 90 | 10 | touch failure | GAT2 | THK | 1.3 | 1 |
| 3 | 90 | 90 | bright spot | GAT1 | THK | 1.5 | 2.463531 |
| | 90 | 90 | bright spot | GAT2 | THK | 1.5 | 2.463531 |
| | 90 | 90 | touch failure | GAT1 | THK | 1.5 | 1 |
| | 90 | 90 | touch failure | GAT2 | THK | 1.5 | 1 |
| 4 | 10 | 90 | bright spot | GAT1 | THK | 1.4 | 0.606581 |
| | 10 | 90 | bright spot | GAT2 | THK | 1.4 | 0.606581 |
| | 10 | 90 | touch failure | GAT1 | THK | 1.4 | 1 |
| | 10 | 90 | touch failure | GAT2 | THK | 1.4 | 1 |
| . . . | | | | | | | |

As shown in Table 6, only some of the influence weights obtained on the basis of Table 4 and Table 5 are shown, for example, in the film layer GAT1, the measurement value at the measurement location (10,10) is 1.2, for the real panel, the influence weight of the defect type “bright spot” is 0.60653; for example, in the film layer GAT2, the measurement value at the measurement location (90,90) is 1.5, and the influence weight of the defect type “bright spot” on the real panel is 2.463531.

In one embodiment, the method further includes:

among the defect locations, determining a target defect location having a distance to the measurement location smaller than a distance threshold; wherein the distance threshold is determined based on R, and (x_{dft}, y_{dft}) belongs to the target defect location.

FIG. 4 is a schematic diagram showing a relationship between a range parameter and an influence weight according to an embodiment of the present disclosure.

As shown in FIG. 4, taking R=20 mm as an example, when R is larger than 60 mm,

$${e}^{- k} \text{?}$$

$$\text{?} \text{indicates text missing or illegible when filed}$$

in the influence weight is approximately equal to 0, that is, the measurement point has basically no effect on the defect beyond 60 mm, so there is no need to consider the influence of the measurement point for a defect at a defect location beyond 60 mm.

Therefore, among the defect locations, a target defect location having a distance to the measurement location smaller than the distance threshold can be determined, and (x_{dft}, y_{dft}) belongs to the target defect location, that is, it is only necessary to substitute defect location closer to the measurement point into the above determination formula for determination, which is beneficial to reduce the calculation amount while not affecting the determination result. The distance threshold can be determined according to R, for example, it can be set to 3 R.

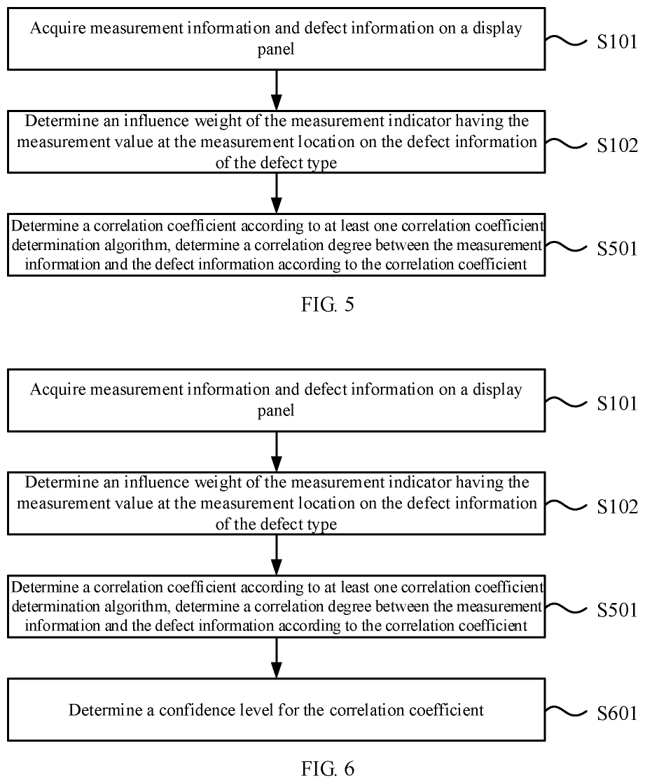

FIG. 5 is a schematic flowchart of yet another method for determining a correlation degree according to an embodiment of the present disclosure. As shown in FIG. 5, determining a correlation coefficient between the influence weight and the measurement value includes the following steps.

In step S501, determining a correlation coefficient according to at least one correlation coefficient determination algorithm.

In one embodiment, the correlation coefficient between influence weights and measurement values can be determined according to whether the set of influence weights and the set of measurement values are on a straight line.

One or more correlation coefficient determination algorithms, such as Pearson algorithm, Spearmans algorithm, etc., can be selected as required.

Taking the Pearson algorithm, and the influence weight shown in Table 6 as an example, the influence weight and the measurement value can be used as x and y in the Pearson algorithm, respectively, which can be expressed in form of a table as shown in Table 7 and Table 8.

TABLE 7

| | | | | | |
|---|---|---|---|---|---|
| X | 1.2 | 1.3 | 1.5 | 1.4 | . . . |
| Y | 0.60653 | 0.606576 | 2.463531 | 0.606581 | |

TABLE 8

| | | | | | |
|---|---|---|---|---|---|
| X | 1.2 | 1.3 | 1.5 | 1.4 | . . . |
| Y | 1 | 1 | 1 | 1 | |

Table 7 is the influence weight of the defect type “bright spot”, and Table 8 is the influence weight of the defect type of “touch failure”.

The Pearson correlation coefficient determined by the Pearson algorithm is mainly used to measure whether the two data sets of x and y are on the same line. The determination formula is as follows:

Correlation coefficient

$$r = \frac{N \sum {x}_{i} {y}_{i} - \sum {x}_{i} {y}_{i}}{\sqrt{N \sum {x}_{i}^{2} - {( \sum {x}_{i} )}^{2} (} \sqrt{N \sum {y}_{i}^{2} - {( \sum {y}_{i} )}^{2}}} .$$

For each defect type, a correlation coefficient can be determined. For example, by substituting the x and y in the above Table 7 into the Pearson correlation coefficient determination formula for calculation, and the obtained correlation coefficient can be used to express a correlation degree between thicknesses and bright spots. For example, by substituting the x and y in the above Table 8 into the Pearson correlation coefficient determination formula for calculation, and the obtained correlation coefficient can be used to represent a correlation degree between thicknesses and touch failures.

FIG. 6 is a schematic flowchart of yet another method for determining a correlation degree according to an embodiment of the present disclosure. As shown in FIG. 6, determining a correlation coefficient between the influence weight and the measurement value further includes the following steps.

In step S601, a confidence level of the correlation coefficient is determined.

In one embodiment, for the determined correlation coefficient, the confidence level of the correlation coefficient can be further determined, so as to determine the reasonableness of the correlation coefficient.

There are many ways to determine the confidence level, which can be selected according to specific needs. For example, a p-value can be determined to represent the confidence level. The t is constructed according to the relevant statistical test theory, and is substituted into the t-distribution, to obtain:

$${t}_{0} = \text{?} ;$$

$$P = Pr ( \vert T \vert > {t}_{0} ) , T \sim t ( N - 2 ) ;$$

$$\text{?} \text{indicates text missing or illegible when filed}$$

where T˜t(N-2) is the t distribution with T composite freedom degrees being N-2.

The values of the correlation coefficient and confidence level can be shown in Table 9.

TABLE 9

| Defect | Measured | Measurement | Correlation | Confidence |
|---|---|---|---|---|
| type | film layer | parameter | coefficient r | level p-value |
| Bright spot | GAT1 | THK | 0.6 | 0.03 |
| Touch | GAT1 | THK | 0.5 | 0.6 |
| failure | | | | |
| Bright spot | GAT2 | THK | 0.6 | 0.03 |
| Touch | GAT2 | THK | 0.5 | 0.6 |
| failure | | | | |
| . . . | | | | |

The smaller the value of the p-value is, the higher the confidence level is. Generally, the correlation coefficient of p-value <0.05 can be determined as a reliable correlation coefficient.

It should be noted that, in addition to determining the Pearson correlation coefficient based on the above embodiment, the correlation coefficient can also be determined in other methods.

In one embodiment, the correlation coefficient between the influence weight and the measurement value can be determined according to a level corresponding to the average descending position of the influence weight among all the influence weights and a level corresponding to the average descending position of the measurement value among all the measurement values.

For example, a Spearmans correlation coefficient can be determined. The measurement values can be classified according to the mean value set by the technological process. The maximum and minimum values of the indicator can be set, and in a form like 5±1, for example, taking 5 as θ, 1 as δ, the numerical conversion formula can be shown in Table 10.

TABLE 10

| Measurement value | Level |
|---|---|
| value > θ + 3δ | 3 |
| θ + 3δ ≥ value > θ + 2δ | 2 |
| θ + 2δ ≥ value > θ + δ | 1 |
| θ + δ ≥ value > θ − δ | 0 |
| δ − δ ≥ value > θ − 2δ | −1 |
| θ − 2δ ≥ value > θ − 3δ | −2 |
| value ≤ θ − 3δ | −3 |

The values of the Spearmans correlation coefficient and confidence level determined based on this can be shown in Table 11.

TABLE 11

| Defect | Measured | Measurement | Correlation | Confidence |
|---|---|---|---|---|
| type | film layer | parameter | coefficient r | level p-value |
| Bright spot | GAT1 | THK | 0.8 | 0.06 |
| Touch | GAT1 | THK | 0.1 | 0.6 |
| failure | | | | |
| Bright spot | GAT2 | THK | 0.7 | 0.04 |
| Touch | GAT2 | THK | 0.22 | 0.6 |
| failure | | | | |
| . . . | | | | |

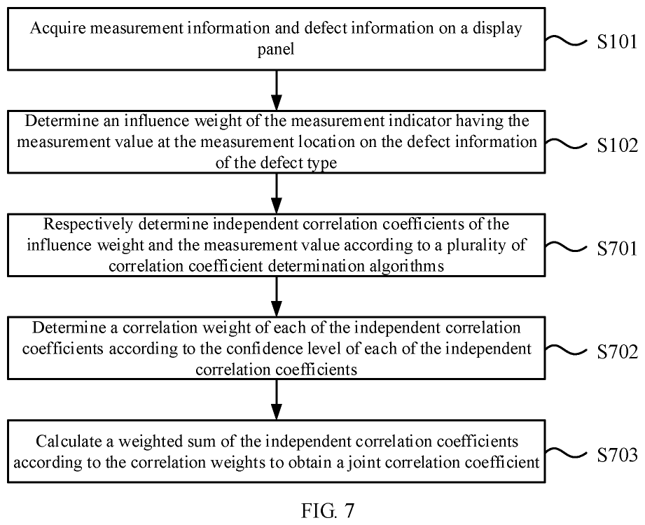

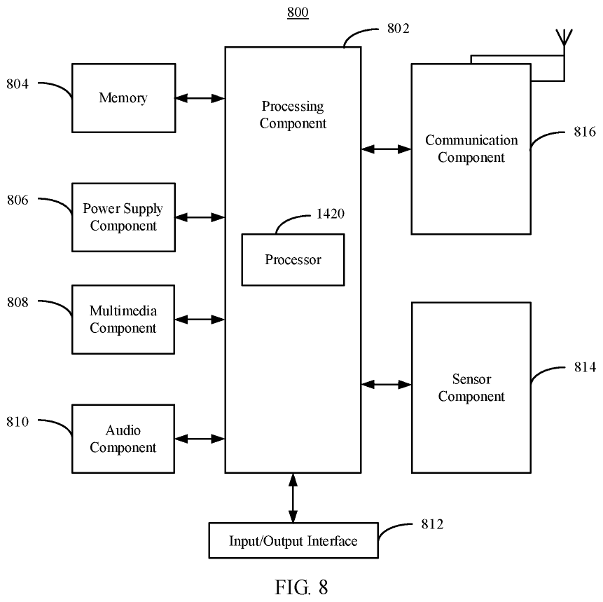

FIG. 7 is a schematic flowchart of yet another method for determining a correlation degree according to an embodiment of the present disclosure. As shown in FIG. 7, determining a correlation coefficient according to at least one correlation coefficient determination algorithm includes the following steps.

In step S701, independent correlation coefficients of the influence weight and the measurement value are respectively determined according to a plurality of correlation coefficient determination algorithms.

Determining the correlation coefficient between the influence weight and the measurement value further includes the following steps.

In step S702, a correlation weight of each of the independent correlation coefficients is determined according to the confidence level of each of the independent correlation coefficients.

In step S703, a weighted sum of the independent correlation coefficients is calculated according to the correlation weights to obtain a joint correlation coefficient.

In one embodiment, the correlation coefficients can be determined respectively according to a plurality of correlation coefficient determination algorithms, and then a weighted sum of the correlation coefficients as determined is calculated to obtain a final correlation coefficient.

For example, the independent correlation coefficients between the influence weight and the measurement value can be determined respectively according to a plurality of correlation coefficient determination algorithms, and then a correlation weight of each independent correlation coefficient can be determined according to the confidence level of each independent correlation coefficient. Finally, a weighted sum of the independent correlation coefficients is calculated from the weights determined.

Taking determining the Pearson correlation coefficient rₚₑᵣₛₒₙ and the Spearmans correlation coefficient rₛₚₑₐᵣₘₐₙₛ as an example, where the confidence level of rₚₑᵣₛₒₙ is pValueₚₑᵣₛₒₙ, and the confidence level of rₛₚₑₐᵣₘₐₙₛ is pValueₛₚₑₐᵣₘₐₙₛ, then a joint correlation coefficient r can be obtained by calculating a weighted sum according to the following formula:

$$r = \text{?} r \text{?} + \text{?} r \text{?}$$

$$\text{?} \text{indicates text missing or illegible when filed}$$

The values of the joint correlation coefficient r and the confidence can be shown in Table 12.

TABLE 12

| Defect | Measured | Measurement | Correlation | Confidence |
|---|---|---|---|---|
| type | film layer | parameter | coefficient r | level p-value |
| Bright spot | GAT1 | THK | 0.67 | 0.03 |
| Touch | GAT1 | THK | 0.30 | 0.6 |
| failure | | | | |
| Bright spot | GAT2 | THK | 0.64 | 0.03 |
| Touch | GAT2 | THK | 0.36 | 0.6 |
| failure | | | | |
| . . . | | | | |

Since the angles considered by the correlation coefficients determined by each algorithm are different, the joint correlation coefficient determined by combining the correlation coefficients settled by multiple algorithms is conducive to ensuring accuracy in more scenarios.

According to the embodiments of the present disclosure, in the user interface UI, pieces of defect information can be displayed separately according to the defect types. The user can click on one of the defect types, and then the steps in the method described in any of the above embodiments can be executed to obtain the correlation degree between the measurement information and the defect information, such as the above correlation coefficient, and the confidence level of each correlation degree Can be further displayed, such as the forms of Table 9, Table 11, and Table 12 in the above embodiment, so that the user can comprehensively analyze the reliability of the correlation degree. The user can also click on any row in the table, then a comparison chart of the measurement information in this row and the defect information on the display panel will be displayed, so that the user can visually check the measurement information and the defect information.

Corresponding to the above-mentioned embodiments of the method for determining a correlation degree, the present disclosure also provides an embodiment of an apparatus for determining a correlation degree.

An embodiment of the present disclosure provides an apparatus for determining a correlation degree, and the apparatus can be a terminal, a server, or other devices. In one embodiment, the apparatus includes one or more processors configured to:
acquire measurement information and defect information on a display panel, wherein the measurement information includes a measurement value and a measurement location for a measurement indicator, and the defect information includes a defect type;
determine an influence weight of the measurement indicator having the measurement value at the measurement location on the defect information of the defect type;
determine a correlation coefficient between the influence weight and the measurement value, and determine a correlation degree between the measurement information and the defect information according to the correlation coefficient.

In one embodiment, the measurement indicator includes at least one of the following: film thickness, resistance, and on-voltage.

In one embodiment, the defect type includes at least one of the following: bright spot, dark spot, bright line, dark line, touch failure, and tolerance.

In one embodiment, the defect information further includes a defect location, and the processor is configured to: for each of the measurement locations, determine an influence weight according to the measurement location and the defect location.

In one embodiment, the processor is configured to: for each of the measurement locations (x₀, y₀), determine the influence weight by:

$$Y \text{?} = \sum \text{?} {e}^{- k} \text{?} ;$$

$$\text{?} \text{indicates text missing or illegible when filed}$$

where (x_{dft}, y_{dft}) denotes a defect location, k denotes an attenuation parameter, and R denotes a range parameter.

In one embodiment, the processor is configured to: among the defect locations, determine a target defect location having a distance to the measurement location smaller than a distance threshold; wherein the distance threshold is determined based on R, and (x_{dft}, y_{dft}) belongs to the target defect location.

In one embodiment, the defect information does not include defect location, and the processor is configured to determine the influence weight as a preset value.

In one embodiment, the processor is configured to determine the correlation coefficient according to at least one correlation coefficient determination algorithm.

In one embodiment, the processor is further configured to determine a confidence level of the correlation coefficient.

In one embodiment, the processor is configured to: respectively determine independent correlation coefficients of the influence weight and the measurement value according to a plurality of correlation coefficient determination algorithms; determine a correlation weight of each of the independent correlation coefficients according to the confidence level of each of the independent correlation coefficients; and calculate a weighted sum of the independent correlation coefficients according to the correlation weights to obtain a joint correlation coefficient.

An embodiment of the present disclosure further provides an electronic device, including: a processor; a memory for storing instructions executable by the processor; wherein the processor is configured to implement the method for determining a correlation degree described in any of the above embodiments.

Embodiments of the present disclosure also provide a computer-readable storage medium, on which a computer program is stored, and when the program is executed by a processor, implements the steps in the method for determining a correlation degree described in any of the above embodiments.

FIG. 8 is a schematic block diagram of an apparatus 800 for determining a correlation degree according to an embodiment of the present disclosure. For example, the apparatus 800 can be a mobile phone, a computer, a digital broadcasting terminal, a messaging device, a game console, a tablet device, a medical device, fitness equipment, a personal digital assistant, or the like.

Referring to FIG. 8, the apparatus 800 can include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operations of the apparatus 800, such as operations associated with display, phone calls, data communications, camera operations, and recording operations. The processing component 802 can include one or more processors 820 to execute instructions to complete all or part of the steps of the above methods. In addition, the processing component 802 can include one or more modules which facilitate the interaction between the processing component 802 and other components. For example, the processing component 802 can include a multimedia module to facilitate the interaction between the multimedia component 808 and the processing component 802.

The memory 804 is to store various types of data to support the operation of the apparatus 800. Examples of such data include instructions for any application or method operated on the apparatus 800, contact data, phonebook data, messages, pictures, videos, and so on. The memory 804 can be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 806 supplies power for different components of the apparatus 800. The power supply component 806 can include a power supply management system, one or more power supplies, and other components associated with generating, managing and distributing power for the apparatus 800.

The multimedia component 808 includes a screen providing an output interface between the apparatus 800 and a user. In some examples, the screen can include a Liquid Crystal Display (LCD) and a Touch Panel (TP). If the screen includes the TP, the screen can be implemented as a touch screen to receive input signals from the user. The TP can include one or more touch sensors to sense touches, swipes, and gestures on the TP. The touch sensors can not only sense a boundary of a touch or swipe, but also sense a duration and a pressure associated with the touch or swipe. In some examples, the multimedia component 808 can include a front camera and/or a rear camera. The front camera and/or rear camera can receive external multimedia data when the apparatus 800 is in an operating mode, such as a photographing mode or a video mode. Each of the front camera and the rear camera can be a fixed optical lens system or have focal length and optical zooming capability.

The audio component 810 is to output and/or input an audio signal. For example, the audio component 810 includes a microphone (MIC). When the apparatus 800 is in an operating mode, such as a call mode, a record mode and a voice recognition mode, the microphone is to receive an external audio signal. The received audio signal can be further stored in the memory 804 or sent via the communication component 816. In some examples, the audio component 810 further includes a speaker for outputting an audio signal.

The I/O interface 812 provides an interface between the processing component 802 and a peripheral interface module. The above peripheral interface module can be a keyboard, a click wheel, buttons, or the like. These buttons can include but not limited to, a home button, a volume button, a start button and a lock button.

The sensor component 814 includes one or more sensors to provide status assessments of various aspects for the apparatus 800. For example, the sensor component 814 can detect the on/off status of the apparatus 800, and relative positioning of component, for example, the component is a display and a keypad of the apparatus 800. The sensor component 814 can also detect a change in position of the apparatus 800 or a component of the apparatus 800, a presence or absence of the contact between a user and the apparatus 800, an orientation or an acceleration/deceleration of the apparatus 800, and a change in temperature of the apparatus 800. The sensor component 814 can include a proximity sensor to detect the presence of a nearby object without any physical contact. The sensor component 814 can further include an optical sensor, such as a Complementary Metal-Oxide-Semiconductor (CMOS) or Charged Coupled Device (CCD) image sensor which is used in imaging applications. In some examples, the sensor component 814 can further include an acceleration sensor, a gyroscope sensor, a magnetic sensor, a pressure sensor, or a temperature sensor.

The communication component 816 is to facilitate wired or wireless communication between the apparatus 800 and other devices. The apparatus 800 can access a wireless network based on a communication standard, such as WiFi, 2G, or 3G, 4G LTE, 5G NR or a combination thereof. In an example, the communication component 816 receives a broadcast signal or broadcast related information from an external broadcast management system via a broadcast channel. In an example, the communication component 816 can further include a Near Field Communication (NFC) module for promoting short-range communication. For example, the NFC module can be implemented based on a radio frequency identification (RFID) technology, an infrared data association (IrDA) technology, an ultra-wideband (UWB) technology, a Bluetooth® (BT) technology and other technologies.

In an example, the apparatus 800 can be implemented by one or more Application Specific Integrated Circuits (ASICs), Digital Signal Processors (DSPs), Digital Signal Processing Devices (DSPDs), programmable Logic Devices (PLDs), Field Programmable Gate Arrays (FPGAs), controllers, microcontrollers, microprocessors, or other electronic components for performing the above method.

In an example, a non-transitory computer readable storage medium including instructions is further provided, such as the memory 804 including instructions. The above instructions can be executed by the processor 820 of the apparatus 800 to complete the above method. For example, the non-transitory computer readable storage medium can be a Read-Only Memory (ROM), a Random Access Memory (RAM), a CD-ROM, a magnetic tape, a floppy disk, an optical data storage device, and so on.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes can be made without departing from the scope thereof. The scope of the present disclosure is limited only by the appended claims.

It should be noted that in this document, relational terms such as first and second are used only to distinguish one entity or action from another, and do not necessarily require or imply these entities or that there is any such actual relationship or sequence between actions. The terms “including”, “comprising” or any other variation thereof are intended to encompass non-exclusive inclusion such that a process, method, article or device comprising a list of elements includes not only those elements, but also other not expressly listed elements, or also include elements inherent to such a process, method, article or device. Without further limitation, an element defined by a phrase “comprising a . . . ” does not preclude the presence of additional identical elements in a process, method, article or device that includes the element.

The methods and devices provided by the embodiments of the present disclosure have been described in detail above, and specific examples are used herein to illustrate the principles and implementations of the present disclosure. The descriptions of the above embodiments are only used to help understand the method of the present disclosure and the core idea thereof. In addition, for those of ordinary skill in the art, according to the idea of the present disclosure, changes can be made to the specific implementation and application scope. Accordingly, the content of the specification should not be interpreted as limitation to the present disclosure.

1. A method for determining a correlation degree, comprising:
acquiring measurement information and defect information on a display panel, wherein the measurement information includes a measurement value and a measurement location for a measurement indicator, and the defect information includes a defect type;
determining an influence weight of the measurement indicator having the measurement value at the measurement location on the defect information of the defect type; and
determining a correlation coefficient between the influence weight and the measurement value, and determining a correlation degree between the measurement information and the defect information according to the correlation coefficient.

2. The method of claim 1, wherein the measurement indicator comprises at least one of:
film thickness, resistance, turn-on voltage.

3. The method of claim 1, wherein the defect type comprises at least one of:
bright spot, dark spot, bright line, dark line, touch failure, resistance.

4. The method of claim 1, wherein the defect information further includes a defect location, and determining an influence weight of the measurement indicator having the measurement value at the measurement location on the defect information of the defect type comprises:
for each measurement location, determining an influence weight according to the measurement location and the defect location.

5. The method of claim 4, wherein the influence weight is inversely correlated with a distance between the measurement location and the defect location.

6. The method of claim 5, wherein, for each measurement location,
determining an influence weight according to the measurement location and the defect location comprises:
for each measurement location x₀, y₀, determining the influence weight by
$$Y \text{?} = \sum \text{?} {e}^{- k} \text{?} ,$$
$$\text{?} \text{indicates text missing or illegible when filed}$$
where x_{dft}, y_{dft} denotes a defect location, k denotes an attenuation parameter, and R denotes a range parameter.

7. The method of claim 6, further comprising:
among the defect locations, determining a target defect location having a distance to the measurement location smaller than a distance threshold; wherein the distance threshold is determined based on R, and x_{dft}, y_{dft} belongs to the target defect location.

8. The method of claim 1, wherein the defect information does not include defect location, and determining an influence weight of the measurement indicator having the measurement value at the measurement location on the defect information of the defect type comprises:
determining the influence weight as a preset value.

9. The method of claim 1, wherein determining a correlation coefficient between the influence weight and the measurement value comprises:
determining a correlation coefficient according to at least one correlation coefficient determination algorithm.

10. The method of claim 9, wherein determining a correlation coefficient between the influence weight and the measurement value further comprises:
determining a confidence level for the correlation coefficient.

11. The method of claim 10, wherein determining a correlation coefficient according to at least one correlation coefficient determination algorithm comprises:
respectively determining independent correlation coefficients of the influence weight and the measurement value according to a plurality of correlation coefficient determination algorithms;
wherein determining a correlation coefficient between the influence weight and the measurement value comprises:
determining a correlation weight of each of the independent correlation coefficients according to the confidence level of each of the independent correlation coefficients; and
calculating a weighted sum of the independent correlation coefficients according to the correlation weights to obtain a joint correlation coefficient.

12. An apparatus for determining a correlation degree, comprising one or more processors configured to:
acquire measurement information and defect information on a display panel, wherein the measurement information includes a measurement value and a measurement location for a measurement indicator, and the defect information includes a defect type;
determine an influence weight of the measurement indicator having the measurement value at the measurement location on the defect information of the defect type; and
determine a correlation coefficient between the influence weight and the measurement value, and determine a correlation degree between the measurement information and the defect information according to the correlation coefficient.

13. The apparatus of claim 12, wherein the defect information further includes a defect location, and the processor is configured to: for each measurement location, determine an influence weight according to the measurement location and the defect location.

14. The apparatus of claim 13, wherein the processor is configured to: for each measurement location x₀, y₀, determine the influence weight by
$$Y \text{?} = \sum \text{?} {e}^{- k} \text{?} ,$$
$$\text{?} \text{indicates text missing or illegible when filed}$$
where x_{dft}, y_{dft} denotes a defect location, k denotes an attenuation parameter, and R denotes a range parameter.

15. The apparatus of claim 14, wherein the processor is configured to: among the defect locations, determine a target defect location having a distance to the measurement location smaller than a distance threshold; wherein the distance threshold is determined based on R, and x_{dft}, y_{dft} belongs to the target defect location.

16. The apparatus of claim 12, wherein the processor is configured to determine a correlation coefficient according to at least one correlation coefficient determination algorithm.

17. The apparatus of claim 16, wherein the processor is further configured to determine a confidence level for the correlation coefficient.

18. The apparatus of claim 17, wherein the processor is configured to respectively determine independent correlation coefficients of the influence weight and the measurement value according to a plurality of correlation coefficient determination algorithms; determine a correlation weight of each of the independent correlation coefficients according to the confidence level of each of the independent correlation coefficients; calculate a weighted sum of the independent correlation coefficients according to the correlation weights to obtain a joint correlation coefficient.

19. An electronic device, comprising:
a processor;
a memory for storing processor-executable instructions;
wherein the processor is configured to implement the method for determining a correlation degree of claim 1.

20. A computer-readable storage medium on which a computer program is stored, wherein when the program is executed by a processor, steps in the method for determining a correlation degree according to claim 1 are implemented.
